(19) United States
(12) Patent Application Publication
(10) Pub. No.: US 2023/0342865 A1
(43) Pub. Date: Oct. 26, 2023

(54) System and Method for Sharing Music in a Social Network

(71) Applicant: Fwaygo, Inc., Sherman Oaks, CA (US)

(72) Inventors: Arthur Jeremy Greene, Sherman Oaks, CA (US); Eli Stewart, Sherman Oaks, CA (US)

(21) Appl. No.: 17/727,653

(22) Filed: Apr. 22, 2022

(51) Int. Cl. G06Q 50/00; H04L 51/52; H04L 67/306; G06F 16/65

(52) U.S. Cl. CPC G06Q 50/01; H04L 51/52; H04L 67/306; G06F 16/65

(57) ABSTRACT

A system and method for sharing music in a social network are provided. Namely, computer processors are configured to receive audio media files as individual tracks from users, receive selections of a portion of each track to highlight from the users themselves, and play such highlighted portions in a continuous feed of highlighted portions of other user-supplied tracks. Tracks may be automatically associated with online profiles of the uploading user as well as, upon request, other users. The system and method may be configured to algorithmically correlate information that qualifies whether and to what extent users of the system “like” each track—or user-artists more generally—and uses such correlations to both identify trends within the social network and present track suggestions to its users.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to digital publication of music and, more particularly, to systems and methods for sharing music by and between members in a digitally implemented social network.

### BACKGROUND

Social media platforms such as TikTok® and Instagram®, among others, have become wildly popular amongst their users, and consequently, increasingly valuable sources of market and consumer trend information used by brands to increase sales and further develop products and services. Various propositions have been made to present users with content that they might be most interested in or, in other words, most likely to engage with such as by “liking,” saving, and sharing with members connected in their social network. One such example includes U.S. Pat. No. 9,342,851 to Musil, which is directed to filtering content of social media activity by processing distinct data sets to identify indicia of media content, and filtering such data sets according to such media content. Others have proposed improving engagement by allowing users to augment content in a social media platform. For instance, U.S. Pat. Pub. No. 2021/0342060 by Dalonzo teaches inserting user-selected, digital stickers as a graphical overlay in a social media content item. Still others have proposed sharing visual media between users in a social network, as in U.S. Pat. No. 9,773,228 to Baldwin et al.

The heavy emphasis on visual content hosted by these platforms tends to overshadow any music that might be incidentally featured, however. As a result, existing social media systems and methods have been insufficient for not only introducing new musical artists to the marketplace, but also for identifying and proliferating trends in the music industry. Thus, although various proposals have been made to share music in a social network, none of those in existence combine the characteristics of the present invention.

### SUMMARY

The present disclosure is directed to systems and methods for sharing audio media in a social network. More particularly, embodiments of the system and method herein described are operative to receive audio media files, namely individual musical tracks, at a user electronic device; implement instructions for highlighting user-selected portions of such track; and playback, alternatively, full tracks or highlighted portions in a continuous feed. As such, the system is defined by at least three modules comprising a content creation module, a playback module, and a content curation module. It should be noted that “track” may refer specifically to a song recorded in a physical medium, such as on vinyl, however, “track” is used herein to refer, as it often is colloquially, to a song or other discrete unit of audio recording even in digital form.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system may comprise a computer system implemented by processors configured to receive identifying information associated with at least a first and second user and generate an online profile for each such user within a social network. Of course, unlimited numbers of users and associated profiles are contemplated, however this disclosure will focus on a first and second user and their associated profiles for the sake of brevity and in the interest of clarity.

The system may be further configured to receive an audio media file as an individual song or track from any user of the system, such as the first user, and receive selections of a portion of such track to highlight from the users themselves. The track, including any selections defining the highlighted portions, may be associated with the user's profile.

In some embodiments, the highlighted portion may comprise a start timestamp and an end timestamp within the track. In some embodiments, the highlighted portion may comprise up to about five (5) seconds of the entire track. In some embodiments, the highlighted portion may comprise up to about 10 seconds of the entire track. In some embodiments, the highlighted portion may comprise up to about 15 seconds of the entire track. In some embodiments, the highlighted portion may comprise from about five (5) seconds to about 30 seconds, or no more than about one minute of the entire track. However, it is contemplated that a highlighted portion of any length selected from the entire track will be sufficient to practice the invention. It may be seen, then, that the system may be configured to identify a selection of just a limited portion of each track as a highlighted portion.

In an embodiment, the system may be configured to play highlighted portions of each track in a continuous feed together with other highlighted portions of tracks received from other users of the system. One of ordinary skill in the art will recognize “feed” as relates to social media usage. In particular, a user's feed in the system and method for sharing music may comprise a playback module comprising continuously streaming tracks and/or highlighted portions of tracks received from other users of the system, or, in other words, other members of the social network.

Thus, it is contemplated that the system may be configured to play just a portion of each track as a sample of the full track in a playback module, successively. It is contemplated that enabling users to select their own highlighted portions may grant artist-users of the system control over samples of their music experienced by other users of the system. However, it is also contemplated that the system may be configured to alternatively play, in succession, the entirety of each track in a user's feed at such user's selection. In some embodiments, the system may default to playing, in succession, the user-defined, highlighted portion of each track unless otherwise instructed.

While it is contemplated that each track may be automatically associated with the online profile of the user it was received from, it is also contemplated that tracks may be associated with the online profiles of other users of the system upon such other users' request. For example, in some embodiments, a user may, at a graphical user interface, make an indication that they “like” a track or otherwise make some selection comprising a request to associate the track with their own profile on the social media network. In some embodiments, the system may be further configured to receive a request from a user to feature other users' tracks in their online profiles. Such request to feature a track may be displayed on the user's profile within a listing of “top” tracks or “favorite” tracks or the like. It is contemplated that top tracks featured in a user's profile may be amended, changed, or removed in part or in whole at each user's discretion. In some embodiments, a listing of the user's “top” or “favorite” tracks may be limited to up to 20 tracks, up to 10 tracks, up to five (5) tracks, up to three (3) tracks, up to two (2) tracks, or even just one (1) track. In some embodiments, a listing of the user's “top” or “favorite” tracks may comprise eight (8) tracks.

It is contemplated that system may be configured to make use of various algorithms to determine which tracks appear in each user's feed, and in which order. As such, it should be apparent that each user's feed may be unique from each other's feed. In some embodiments, the order and even frequency that such tracks are presented in each user's feed may be determined algorithmically according to requests made by other users of the system related to such tracks. For instance, relatively high-volume requests from users to associate a particular track with their own online profile—which may be indicated by “likes,” known to those of ordinary skill in the art—may be algorithmically identified by the system and cause the system to play such track with higher frequency going forward. In other words, the system and method may be configured to algorithmically correlate information that qualifies whether and to what extent users of the system “like” each track—or user-artists more generally—and may, in some embodiments, use such correlations to both identify trends within the social network and present track suggestions to its users.

It is contemplated that each track, however associated with a user's profile, may comprise a streamable URL clickable by each other user of the social network configured to instruct the system to playback such track when selected by a user.

In some embodiments, the system may provide additional, clickable links to enable navigation to each user's profile and the like. Indeed, in some embodiments, the system may be configured to receive a request from a user to associate another user with their profile. In other words, the system may enable users to “like” or “follow” other users of the system, and such likes and follows may be listed or otherwise reflected in each user's profile.

In some embodiments, the system may be further configured to respond to discretionary user requests to skip, pause, resume, and hide tracks or highlighted portions of such tracks, as the case may be, in their feed during playback.

It is contemplated that providing a system and method for sharing music according to the disclosure and claims provided below may beneficially
a) provide user-control over how samples of their work are presented to an audience;
b) aid identification of trends in music;
c) broadcast selections defining a user's media consumption and interest(s) amongst members in a social network; and
d) tailor media presented to users to each individual user themselves.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a diagram of certain system components in an embodiment of the system for sharing music in a social network.

FIG. 2 is a flowchart depicting an exemplary embodiment of a method for sharing music in a social network.

FIG. 3 shows an exemplary embodiment of a computing device shown in FIG. 1.

FIG. 4 is a flowchart depicting an exemplary method carried out in the content creation module of the system shown in FIG. 3.

FIG. 5 shows an exemplary embodiment of the user interface for the system and method for sharing music in a social network.

FIG. 6 illustrates an exemplary embodiment of the user interface for the system and method for sharing music in a social network associated in particular with the content creation module.

FIG. 7 shows a chart depicting an exemplary method carried out in the playback module of the system shown in FIG. 3.

FIGS. 8A-8C illustrate exemplary embodiments of the user interface for the system and method for sharing music in a social network associated in particular with the playback module.

FIGS. 9A-9B illustrate exemplary embodiments of the user interface for the system and method for sharing music in a social network associated in particular with the content curation module of the system shown in FIG. 3.

FIGS. 10A-10B illustrate additional exemplary embodiments of the user interface for the system and method for sharing music in a social network associated in particular with the playback module.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

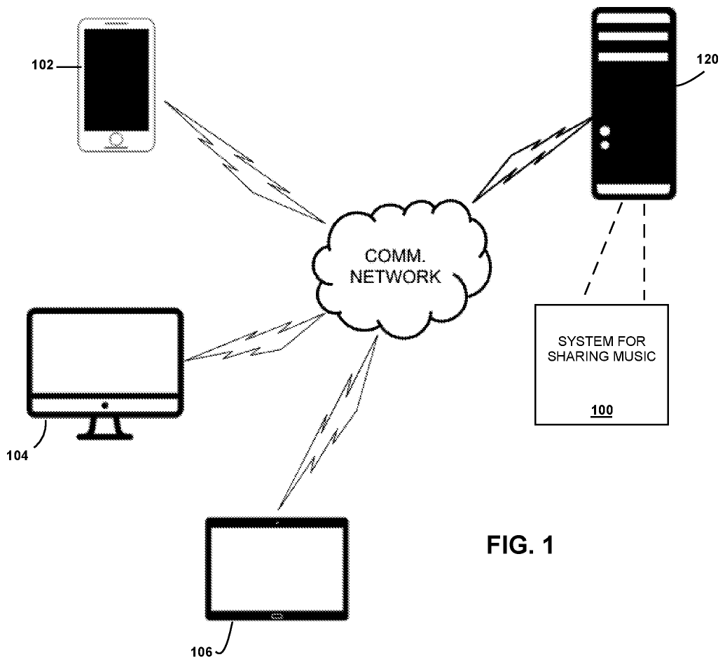

A description of an embodiment of a method and system for sharing music in a social network is now described followed by a discussion of the operation of various components within the system. In this regard, FIG. 1 is a block diagram of a networked environment in which an exemplary embodiment of a system for sharing music is implemented.

FIG. 1 illustrates an exemplary embodiment of the system for sharing music 100 which includes a plurality of computing devices communicatively coupled to one another. By way of example, and not limitation, FIG. 1 illustrates three computing devices 102, 104 and 106 communicatively coupled via a communication network 108. Each of the computing devices may be embodied as any computing device or even mobile computing device such as, for example and without limitation, a smartphone or tablet computer that incorporates cellular telephone functionality. Notably, the communications network can use one or more of various communications types such as, for example and without limitation, cellular and Wi-Fi communications.

Users of computing devices 102, 104 and 106 may be members of a social network. The social network enables members to use their devices 102, 104 and 106 to interact with each other. Typically, a social network is facilitated by a website that may require a registration and login prior to use. However, regardless of how such a social network is implemented, the functionality of concern involves the ability to provide interaction among a limited group of members, as may be established by the members themselves.

In one embodiment, one way to add a member to a social network is to prompt them to enter identification information such as, by way of example only and not limitation, name and email address. In some non-limiting embodiments, the identification information may comprise a user-defined username and password, and even the user's geographic location, biographical information, and usernames on other social media platforms. Upon complying with the membership requirements, the new member will be given access, using their computing device 104, to all of the privileges enjoyed by the first member on their device 102. In operation, the system 100 provides a better and more coordinated way in which a group of real-word or virtual friends—sometimes termed “followers”—and other members, such as recording artists, and those interested in listening to and sharing user-created music and even identifying trends in music, may interact with one another. Specifically, the system 100 enables its users to upload their own music as individual audio files, or tracks, identify a portion of each track to highlight in a continuous feed of other user-supplied tracks, and algorithmically correlate information that qualifies whether and to what extent users of the system “like” each track—or user-artists more generally—and uses such correlations to both identify trends within the social network and present track suggestions to its users.

In this regard, the system 100 includes various modules, which can be implemented in numerous ways such as, for example and without limitation, an application hosted on a network server 120 and executed on the computing device. In operation, the system 100 receives member information to uniquely identify members of the social network 110 (in this case, users of computing devices 102, 104 and 106). Additionally, system 100 receives information corresponding to any tracks supplied by each user, user-identified highlighted portions of each track they have supplied, which users “like” or listen to each track, the extent to which each track is shared amongst users, and other information.

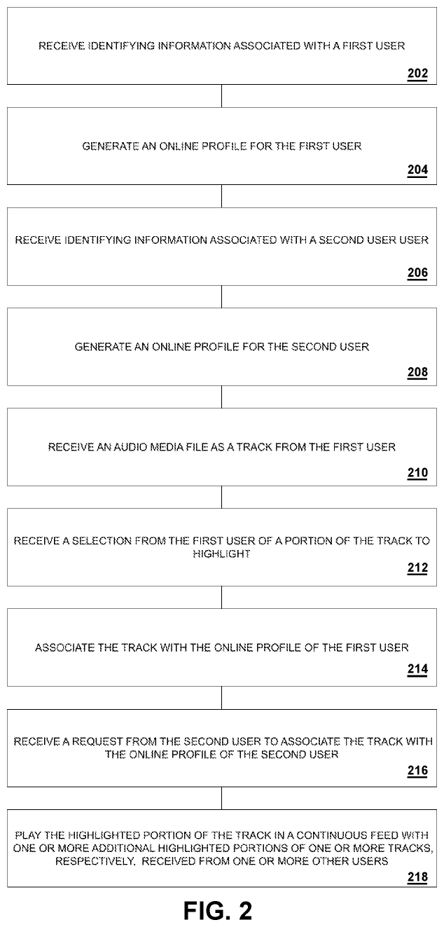

FIG. 2 is a flowchart depicting an exemplary embodiment of a system and method for sharing music in a social network such as may be performed by computing device 102 104, and 106 of FIG. 1. As shown in FIG. 2, the method includes the steps of: receiving identifying information associated with at least a first user and generating an online profile for such user (blocks 202, 204); receiving identifying information associated with at least a second user and generating an online profile for such user (blocks 206, 208); receiving an audio media file as a track—or in other words, a song—from the first user (block 210); receiving a selection from the first user of a portion of the track to highlight (block 212); associating the track with the online profile of the first user (block 214); receiving a request from the second user to associate the track with the online profile of the second user (block 216); and playing such highlighted portion in a continuous feed together with one or more additional track highlighted portions of one or more audio media files received from one or more other users, respectively (block 218).

It is contemplated that each profile will be generated within a social network system as described above, and further that each association of the track with any online profiles of the systems users will also occur within the social networking system.

In some embodiments, highlighting a portion of a track may make use of audio media editors known to those of ordinary skill in the art. In some embodiments, receiving a selection from the first user of a portion of the track to highlight may comprise receiving a selection from the user of a start timestamp and an end timestamp within the track. The particular highlight selection may be left to the discretion of the user; however, it is contemplated that the system may be configured to limit the length of the selection. For instance, the highlighted portion may be limited to no more than one minute, no more than 45 seconds, no more than 30 seconds, no more than 20 seconds, no more than 15 seconds, no more than 10 seconds, or nor more than five seconds of the entire track. It is contemplated that this will enable users to identify for themselves which portion of each of their tracks to present in shortened form as a sample of the entire track to, for instance, strike a desired impact on or pique interest in other users in a continuous feed of other track samples.

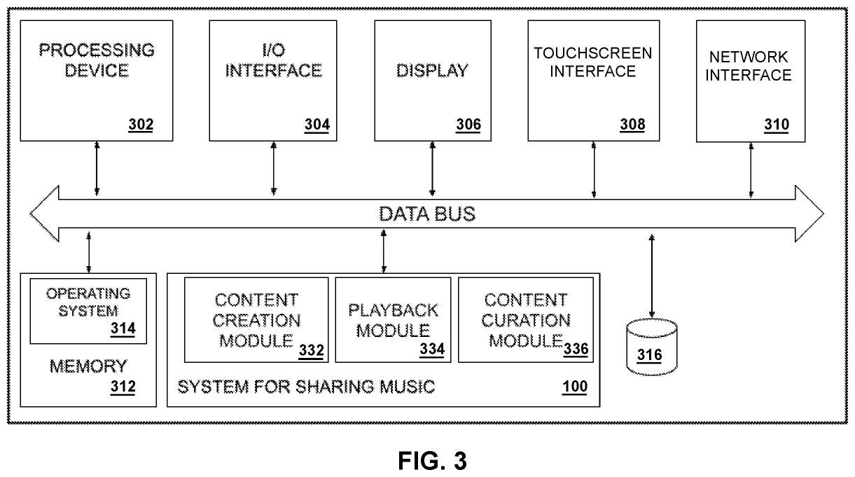

FIG. 3 illustrates exemplary computing device 102 shown in FIG. 1. As described earlier, computing device 102 may be a tablet computer or smartphone but may also be embodied in any one of a wide variety of wired and/or wireless computing devices. As shown in FIG. 3, computing device 102 includes a processing device (processor) 302, input/output interfaces 304, a display 306, a touchscreen interface 308, a network interface 310, a memory 312, and operating system 314, and a mass storage 316 with each communicating across a local data bus 320. In some embodiments, the device 102 may further comprise GPS and even a camera, not pictured. Additionally, computing device 102 incorporates a system for sharing music 100, which is depicted as including the content creation module 332, playback module 334 and content curation module 336, although the location of information 332, 334 and 336 could vary. Each module comprises certain information and data, or is configured to receive and execute instructions related to certain information and data which will become clearer with reference to the particular methods and exemplary user interfaces discussed, in turn, below.

The processing device 302 may include any custom made or commercially available processor, a central processing unit (CPU) or an auxiliary processor among several processors associated with the computing device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the computing device 102. In accordance with such embodiments, the components are stored in memory and executed by the processing device. Note that although depicted separately in FIG. 3, the system and method for coordinating visits 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the computing device 102 will comprise GPS 318 or other means to determine the location of the computing device 102.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

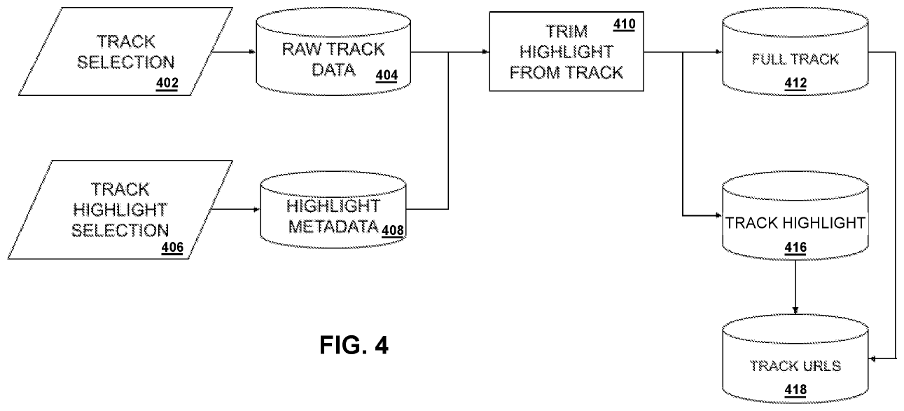

FIG. 4 comprises a chart depicting a method that enables one aspect of the system for sharing music as carried out in the exemplary content creation module shown in FIG. 3. More particularly, and returning to FIG. 4, the system at such module may be configured to receive a track selection 402 and associated raw track data 404. Likewise, the system may be configured to receive, from a user, a selection of some portion of the track to highlight 406, and thus, associated highlight metadata 408. In some embodiments, the highlight may comprise a portion of the track defined by a user-selected start timestamp and a user-selected end timestamp from within the track, and the system may be configured to trim such highlight from the track 410. Then each full track and track highlight 412, 416 may be stored. It is noted that each full track 412 and track highlight 416 may be further stored in or otherwise accessible from a database comprising URLs configured to carry each full track or track highlight as an audio stream, known to those of ordinary skill in the art.

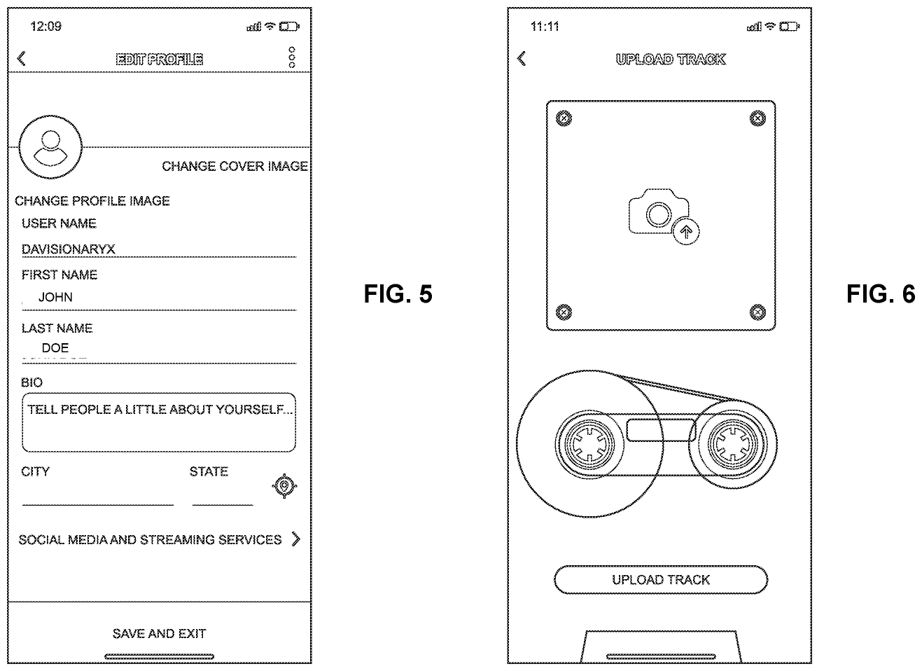

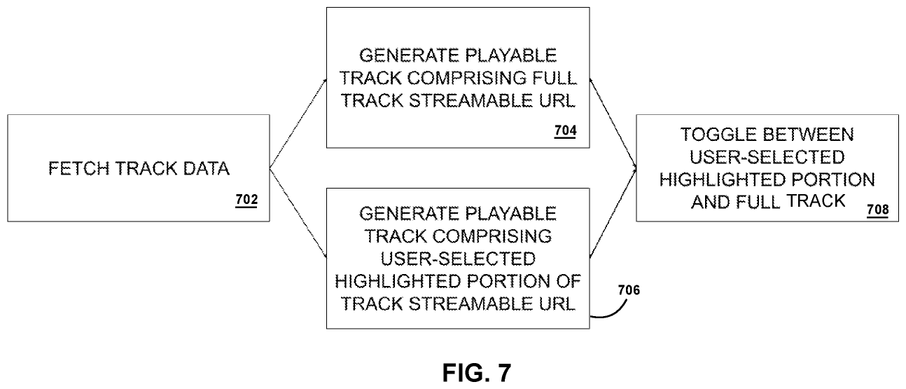

The content creation module may be further understood with reference to exemplary, non-limiting embodiments of a user interface, shown in FIGS. 5 and 6. Namely, as in FIG. 5, the system may comprise a computer system implemented by processors configured to receive identifying information from a user and present some or all of such information in a profile visible to other members of the social network. Thus the system may, at a graphical user interface, prompt a user to provide their own USER NAME, here “DAVISONARYX” FIRST NAME (here, JOHN), LAST NAME (here DOE), BIO, CITY and STATE to identify themselves to other users of the system.

The system may be further configured to receive an audio media file as an individual song or “track” from the exemplary user of the system, as illustrated in FIG. 6. Namely, the system may be configured to prompt a user to “UPLOAD [their] TRACK”. Of course, one skilled in the art will recognize that user responses to prompts may be carried out by the user and received by the system through various clickable elements on the graphical user interface. In this case, UPLOAD TRACK may appear on a clickable button. Upon receipt of a track to upload, the system may further prompt the user to provide and, in response, receive selections of a portion of the uploaded track to highlight from the user themselves, as described above.

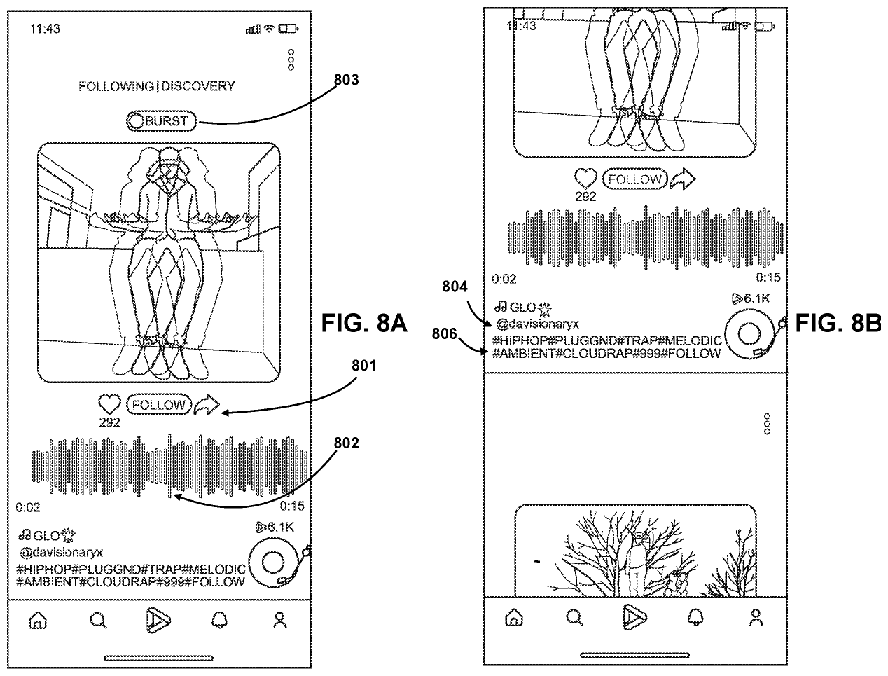

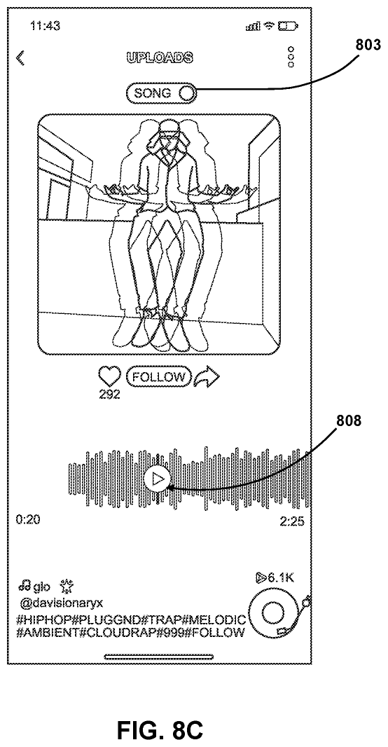

FIG. 7 comprises a chart depicting a method that enables one aspect of the system for sharing music as carried out in the exemplary playback module shown in FIG. 3. More particularly, the system may be configured to carry out instructions to fetch—or retrieve data defining a track 702. These are terms of art know to those of ordinary skill in the art and shall be recognized as synonymous with a step of receiving an audio media file as a track from a user. From such track data, the system may, in the playback module, be configured to generate, in the alternative, a playable track comprising the full track streamable URL 704, and a playable track comprising a user-selected highlighted portion of the track streamable URL 706. The system may be configured to toggle, at the user's discretion, between such full track and highlighted portions 708. FIGS. 8A-8C illustrate exemplary user interfaces reflecting such method.

With particular reference to FIG. 8, each user's feed may be presented in the playback module as a continuous stream of tracks provided by users in the social network. In some embodiments, the feed may comprise an algorithmically determined stream of tracks uploaded to the system at large. This may be considered a recommendation feed or “DISCOVERY” mode.

In some embodiments, the feed may comprise a stream of tracks that a user is “FOLLOWING”. This may comprise those tracks, for example, that the user has requested of the system to be associated with their own online profile. In some embodiments, tracks and/or highlighted portions of such tracks in FOLLOWING mode may appear chronologically according to when each track was uploaded by a user. In some embodiments, tracks and/or highlighted portions of such tracks in FOLLOWING mode may be presented at random. In some embodiments, the order and frequency of tracks played back in a FOLLOWING mode feed may also be algorithmically determined.

To aid the development or continued maintenance of any algorithms, clickable buttons may be provided in the feed and on the graphical user interface which enable a user to request to associate a track with their online profile. In the present example, a user may do so by clicking symbols to like, follow, or share a track 801.

Indeed, it is contemplated that system may be configured to make use of various algorithms to determine which tracks appear in each user's feed, and in which order. In some embodiments, the order and even frequency that such tracks are presented in each user's feed may be determined algorithmically according to requests made by other users of the system related to such tracks. For instance, relatively high-volume requests from users to associate a particular track with their own online profile—which may be indicated by “likes”—or even requests to feature certain associated tracks within their profile, may be algorithmically identified by the system and cause the system to play such track with higher frequency going forward. In other words, the system and method may be configured to algorithmically correlate information that qualifies whether and to what extent users of the system “like” each track—or user-artists more generally—and may, in some embodiments, use such correlations to both identify trends within the social network and present track suggestions to its users. Indeed, in some embodiments, algorithms may identify any tracks that other users associated with a user's account have featured in their own accounts and present such tracks in the user's DISCOVERY mode feed.

In light of the foregoing, it should be apparent that each user's feed may be, though is not necessarily, unique from each other user's feed.

Of course, categorical titles are provided for example only and shall not limit the invention.

The system may receive requests to present variations of the feed at each user's own discretion. Indeed, in some embodiments, it is contemplated that the system may be configured to playback a feed defined by those tracks requested of the system to be associated with another user's profile. Thus, it may be seen that the particular content of the feed in the playback module will not limit the invention.

In an embodiment, the system may be configured to play highlighted portions of each track in a continuous feed together with other highlighted portions of tracks received from other users of the system. In the exemplary embodiment, of FIG. 8A, such highlighted portion 802 of the track appears in visually distinguished soundwaves presented on the graphical user interface. As a further indication, a clickable toggle 803 may be provided to allow users to request the system to playback only highlighted portions of each track (here termed “BURST” mode), or as in FIG. 8C, in “SONG” mode. As noted above, in some embodiments, the highlighted portion may be up to about five (5) seconds long. In some embodiments, the highlighted portion may be up to about 10 seconds long. In some embodiments, the highlighted portion may be up to about 15 seconds long. In some embodiments, the highlighted portion may be from about five (5) seconds long to about 30 seconds long or no more than about one minute long. It may be seen, then, that the system may be configured to identify and playback user-selected, limited portion of each track as a highlighted portion.

As shown in FIG. 8B, the feed may be continuous. That is tracks, or highlighted portions of the same, may be played successively from one another. Of course, other information may be presented and even be made interactive in the feed as well. For instance, the name of the user who uploaded the track may be presented 804 together with user or algorithmically defined “hashtags” 806, known to those of ordinary skill in the art, for categorizing each track or highlighted portion.

Although it is contemplated that enabling users to select their own highlighted portions may grant artist-users of the system control over samples of their music experienced by other users of the system, it is also contemplated that the system may be configured to alternatively play, in succession, the entirety of each track in a user's feed at such user's selection as shown in FIG. 8C. In some embodiments, the system may default to playing, in succession, the user-defined, highlighted portion of each track unless otherwise instructed. In some embodiments, the system may be further configured to respond to discretionary user requests to play, skip, pause, resume, and hide tracks or highlighted portions of such tracks, as the case may be, in their feed during playback. Such requests may be received by the system through visible or invisible clickable elements on the graphical user interface. For instance, a play (or pause, as the case may be) button 808 may be provided. However, these clickable elements may be incorporated into other features on the graphical user interface, such as the cover art.

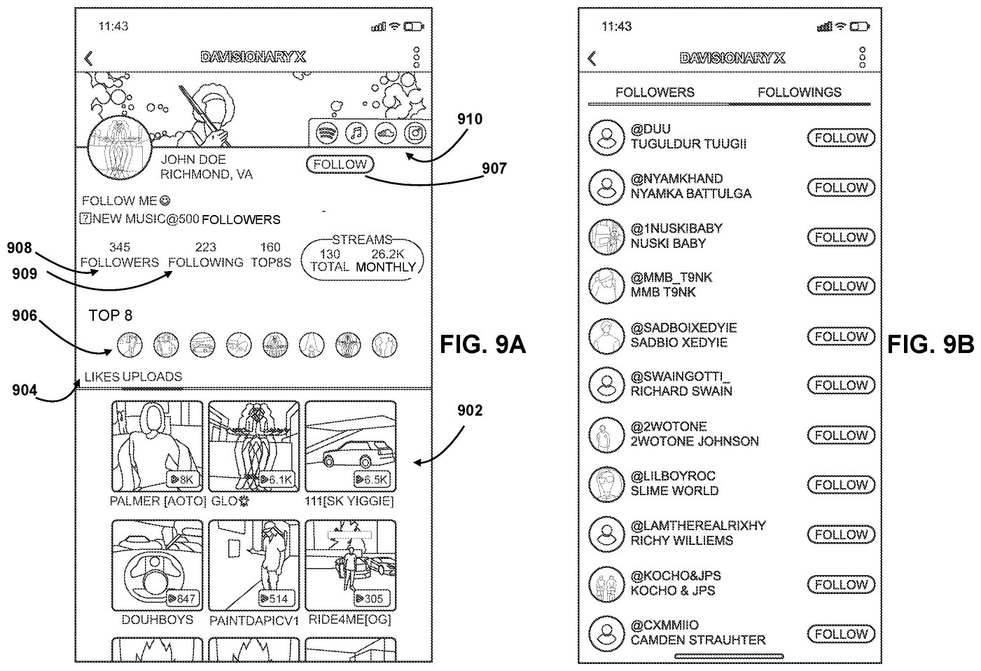

Any and all tracks received from a user, including any selections defining the highlighted portions, may be associated with the user's profile as, for example, “UPLOADS” shown in the exemplary user profile of FIG. 9A. In particular, each track uploaded by the user may be presented in list or icon form 902.

It is also contemplated that tracks may be associated with the online profiles of other users of the system upon such other users' request, such as those tracks which a user “LIKES” 904.

In some embodiments, the system may be further configured to receive a request from a user to feature other users' tracks in their online profiles. Such request to feature a track may be set apart from exemplary uploaded or liked tracks on the user's profile within a listing of “top” tracks 906 or “favorite” tracks or the like. It is contemplated that top tracks featured in a user's profile may be amended, changed, or removed in part or in whole at each user's discretion. In some embodiments, a listing of the user's “top” or “favorite” tracks may be limited to up to 20 tracks, up to 10 tracks, up to five (5) tracks, up to three (3) tracks, up to two (2) tracks, or even just one (1) track. In some embodiments, a listing of the user's “top” or “favorite” tracks may comprise eight (8) tracks. It is contemplated that each track, however associated with a user's profile, may comprise a streamable URL clickable by each other user of the social network configured to instruct the system to playback such track when selected by a user.

In some embodiments, the system may be configured to receive a request from a user to associate another user with their profile such as by a “FOLLOW” button 907. These associations may be reflected in certain statistical provided at the user profile. For instance, the number of users following 908 and/or followed by 909 the user may be presented. Other figures, such as the TOTAL and MONTHLY number of streams in other users' feeds of any tracks uploaded by the user may be presented as well.

In some embodiments, the system may provide additional, clickable links to enable navigation to each user's profile and the like. With reference to FIG. 9B, for instance, a clickable listing of those users that user DAVISIONARYX is following is provided. Similarly, returning to FIG. 9A, clickable links to enable navigation to user's other social media platforms may be provided 910. In other words, the system may enable users to “like” or “follow” other users of the system, and such likes and follows may be listed or otherwise reflected in each user's profile.

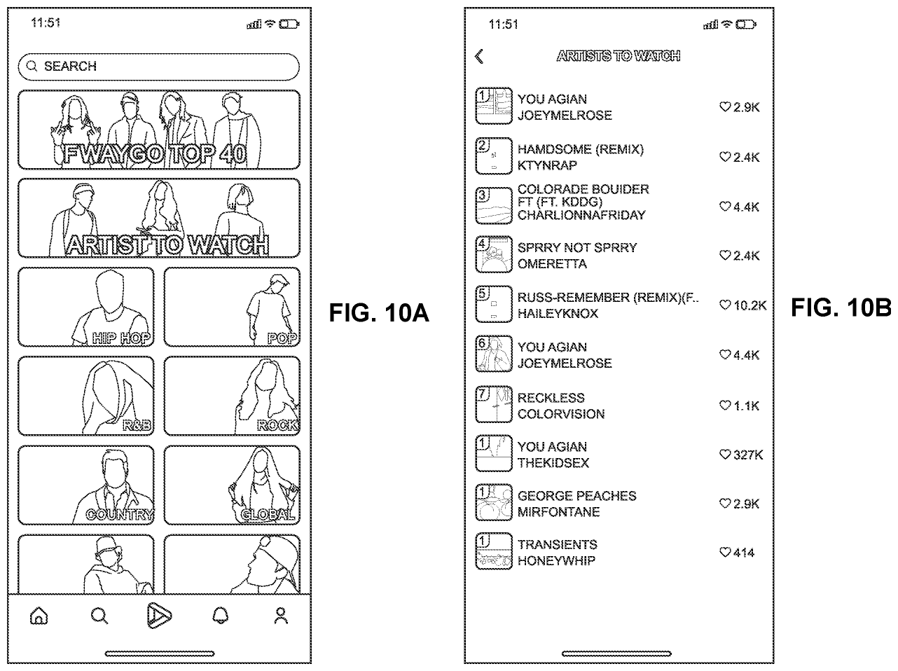

With reference to FIGS. 10A and 10B, tracks may also be accessed outside of each user's feed and/or profile. Indeed, the system receive search requests for particular tracks, or present groupings of tracks to stream according to categories, such as genre. In some embodiments, the system may algorithmically present tracks in groupings according to popularity, as for example only and not limitation, a TOP 40 (or as per any other ranking system) and/or ARTISTS TO WATCH.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the appearance of any user interface, as well as the particular form and content of user- and algorithmically-selected information displayed on such user interface may vary without departing from the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for sharing music in a social network with which that terminology is associated. In general, the terms used in the following claims should not be constructed to limit the system and method for sharing music in a social network to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for sharing music in a social network is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for sharing music in a social network.

What is claimed is:

1. A computer implemented method for sharing audio media in a social network, comprising:
by a computer system comprising a processor:
receiving identifying information associated with at least a first and second user;
generating an online profile for each of the at least first and second user within a social network system;
receiving an audio media file as a track from the first user;
receiving a selection from the first user of a portion of the track to highlight, such highlighted portion comprising a start timestamp and an end timestamp within the track;
associating the track with the online profile of the first user within the social network system; and
playing such highlighted portion for the second user in a continuous feed together with one or more additional track highlighted portions of one or more audio media files received from one or more other users, respectively.

2. The method of claim 1, wherein the highlighted portion is five seconds to twenty seconds long.

3. The method of claim 1, wherein the highlighted portion is up to fifteen seconds long.

4. The method of claim 1, wherein playing such highlighted portion in a continuous feed comprises executing an algorithm to identify and play, alternatively, highlighted portions or tracks of interest to each user of the system.

5. The method of claim 5, further comprising receiving a request from the second user to associate the track with the online profile of the second user within the social networking system.

6. The method of claim 5, wherein the continuous feed further comprises a plurality of, alternatively, tracks and highlighted portions of such tracks, that such user has requested to associate with such user's online profile within the social networking system.

7. The method of claim 1, further comprising, by the computing system, algorithmically categorizing a plurality of tracks by one or more groupings consisting of genre and popularity.

8. The method of claim 1, further comprising, by the computer system, receiving a request from the second user to feature the track in the online profile of the second user within the social networking system.

9. The method of claim 1, further comprising, by the computing system, responsive to receiving a request from a user, playing tracks in a continuous feed together with one or more additional tracks of one or more audio media files received from one or more other users, respectively.

10. A system for sharing audio media in a social network, comprising:
a processor; and
a tangible, non-transitory memory configured to communicate with the processor, the tangible, non-transitory memory having instructions stored thereon that, in response to execution by the processor, cause the processor to perform the method comprising:
receiving identifying information associated with at least a first and second user;
generating an online profile for each of the at least first and second user within a social network system;
receiving an audio media file as a track from the first user;
receiving a selection from the first user of a portion of the track to highlight, such highlighted portion comprising a start timestamp and an end timestamp within the track;
associating the track with the online profile of the first user within the social network system;
receiving a request from the second user to associate the track with the online profile of the second user within the social networking system;
responsive to receiving a request from a user, playing such tracks and track highlighted portions, alternatively, in a continuous feed together with one or more additional tracks and track highlighted portions of one or more audio media files received from one or more other users; and
responsive to receiving a request from a user, playing such tracks and highlighted portions of such tracks, alternatively, that such user has requested to associate with such user's online profile within the social networking system in a continuous feed.

11. The system of claim 8, wherein the highlighted portion is five seconds to twenty seconds long.

12. The system of claim 8, wherein the highlighted portion is up to fifteen seconds long.

13. The system of claim 8, wherein playing such highlighted portion in a continuous feed comprises executing an algorithm to identify and play, alternatively, highlighted portions or tracks of interest to each user of the system.

14. The system of claim 8, further comprising, by the processor, algorithmically categorizing a plurality of tracks by one or more groupings consisting of genre and popularity.

15. The system of claim 8, further comprising, by the processor, receiving a request from the second user to feature the track in the online profile of the second user within the social networking system.

16. The system of claim 8, further comprising, by the processor, responsive to receiving a request from a user, playing tracks in a continuous feed together with one or more additional tracks of one or more audio media files received from one or more other users, respectively.
